(19) United States
(12) Patent Application Publication
(10) Pub. No.: US 2011/0313834 A1
(43) Pub. Date: Dec. 22, 2011

(54) ELICITING SOCIAL SEARCH RESPONSES FROM SPONSORING AGENTS

(75) Inventor: Kamal Jain, Bellevue, WA (US)

(73) Assignee: Microsoft Corporation, Redmond, WA (US)

(21) Appl. No.: 12/820,323

(22) Filed: Jun. 22, 2010

(51) Int. Cl. G06Q 30/00; G06Q 99/00; G06F 15/18

(52) U.S. Cl. 705/14.16; 706/12; 705/14.69; 705/14.71

(57) ABSTRACT

A user may submit to a set of users a query relating to a commercial transaction, and may evaluate the responses provided therefrom. However, the set of users may include vendors or their representatives who might present inaccurate or misleading information in order to persuade the user to purchase the product, or may provide low-quality and impersonal advertisements for a product that do not particularly relate to the query or the user. Instead, the query may be offered to agents who can provide relevant responses, and a response from an agent may be provided to the user in exchange for a response fee charged to the agent. This cost model may promote selectivity and high relevance to the query in the submission of responses from knowledgeable responders, thereby eliciting higher-value responses to the query for the user and financial sponsorship to cover the operating costs of the agent network.

### BACKGROUND

Within the field of computing, many scenarios involve a query submitted by a user regarding a particular commercial topic, such as a solicitation of services; a request for a product recommendation, review, or offer; or a question about particular aspects (e.g., features, details, costs, or effectiveness in particular circumstances) of a product or service. In many scenarios, this query may be submitted to an automated search engine that may endeavor to provide information and/or references to sources of information (such as uniform resource identifiers (URIs) linking to various websites that may be related to such topics). However, in other scenarios, the query may be submitted to a group of individuals who may choose to respond. For example, in a web forum, a user may submit a question regarding a product or service, and other users of the web forum may choose to provide responses that address the question. Responses received from individuals may be more informative, reliable, or apropos than results generated by a search engine, such as questions that have not previously been asked (e.g., questions that are dependent on many factors that are specific to the user, such as “can someone recommend a product for my particular circumstances?”)

Another recent trend within the field of computing relates to social networking, wherein users may establish associations representing relationships with other users, and may share data of interest with all or some associated users. In this context, a user may establish a social profile comprising data that identifies various aspects of the user to associated users, such as demographic information, a set of interests such as hobbies or professional skills, and a set of resources that are interesting to the user. Users may consent to having some aspects of his or her social profile shared; e.g., a user might author a message (such as a personal status, a note about a particular topic, or a message directed to another user) that may initially be accessible only to users who are associated with the user, but may permit an associated user to repost the message for access by all of the users associated with the associated user (e.g., a friend of a user may be permitted to take the user's message and repost it to grant access to the friend's friends.) In this manner, data shared over a social network (and, in particular, data comprising the social profile of a user) may be propagated in select ways to others via the social network.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In some scenarios involving a query submitted by a user, it may be advantageous to deliver the query to one or more agents who may be identified as capable of providing a response that is relevant to the query, such as the vendor of a product referenced in a query, a product expert in a product field related to the query, or a service provider of a service solicited in the query. These agents may have an incentive to respond to the query, as the response may influence the user regarding a commercial transaction (e.g., a purchase of a product from the vendor, an influence on the user in the product area that may result in a commission for the product expert, or an engagement of the services of the service provider.) The user who submitted the query may also benefit from the knowledgeable responses of such agents.

However, several drawbacks may arise within this general arrangement. As a first example, an agent may have an incentive to respond broadly to many queries, such as by automatically advertising the products or services of the agent. Although a high proportion of the responses may not influence the users, even a small influence on a small proportion of users may financially incentivize this behavior in a similar model as unsolicited bulk email messages (“spam”). As a second example, if the volume of submitted queries is large, an agent may have difficulty identifying particular queries for which to evaluate a response; e.g., even the process of sorting through the set of queries to choose those warranting responses may be inefficient for the agent. As a third example, a user may receive a large number of responses in response to a query; e.g., every major product vendor may respond to a query associated with a product area, and the volume of responses may be overwhelming to the user. As a fourth example, the infrastructure for coordinating the query and response system may entail significant costs (e.g., machine acquisition and maintenance, network bandwidth, and human capital), and the administrators of the infrastructure may seek sponsorship to offset these administrative costs. While advertising may provide some sponsorship, the inclusion of advertising may dilute the value of the experience for users (e.g., by embedding valuable responses within many advertisements that do not particularly relate to the query submitted by the user).

Presented herein are techniques for eliciting responses to queries submitted by various users from agents in a manner that leverages the interests of each group. These techniques involve, for a particular query, a careful selection of a small set of agents who are likely to respond to the query, and who may be capable of providing responses that are relevant to the query. Moreover, the query may be offered to these agents in exchange for a response fee. If the agent chooses to submit a response, the response may be provided to the user, and the response fee may be charged to the agent. This arrangement may present particular advantages to each party. Each agent is incentivized to provide high-quality responses that may encourage the user to enter into a commercial transaction that may (directly or indirectly) benefit the agent in excess of the response fee, and to avoid providing responses that are not likely to persuade the user and that do not offset the response fee. The selectivity among agents to whom the query is offered may also improve the effectiveness of a response by a particular agent to the user by reducing the number of low-quality responses from other agents. The user may benefit from receiving a small set of highly responsive and accurate responses to the query, and the administrators of the query and response coordinating system may receive response fees from the agents that may support the costs of providing and maintaining the infrastructure. Additionally, the value to the user may be further improved by submitting the query to one or more associated users who have an association (such as a familial relationship, friendship, professional or academic association, or shared membership in a social group) with the user within the social network, and the responses provided by the associated users may be combined with the responses provided by the agents to produce for the user a personalized and knowledgeable set of responses to the query.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring a submission of a query generated by a user to a set of information sources.

FIG. 2 is an illustration of an exemplary scenario of an agent network configured to elicit at least one response to a query of a user from at least one agent of an agent set in accordance with the techniques presented herein.

FIG. 3 is a flow chart illustrating an exemplary method of eliciting at least one response to a query of a user from at least one agent of an agent set in accordance with the techniques presented herein.

FIG. 4 is a component block diagram illustrating an exemplary system for eliciting at least one response to a query of a user from at least one agent of an agent set in accordance with the techniques presented herein.

FIG. 5 is an illustration of an exemplary computer-readable medium comprising processor-executable instructions configured to embody one or more of the provisions set forth herein.

FIG. 6 is an illustration of an exemplary scenario featuring a prediction of a response probability and a response relevance from various responders using a learning component.

FIG. 7 is an illustration of an exemplary scenario featuring a presentation of responses to a query integrating responses received from associated users of a social network and responses received from responders.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Within the field of computing, many scenarios involve a query submitted by a user regarding a topic that may have a commercial aspect. As a first example, a user may post a question about a product, such as the overall quality, the inclusion and value of particular features, and compatibility with other products. As a second example, a user may express an interest in a particular product area or service area, and may request a recommendation for a particular product or service within the area or a comparison among such products or services. As a third example, a user may ask how to complete a particular task or achieve a particular result, and may solicit products or services that may facilitate the performance of the task or the achievement of the result. The query might also be formulated indirectly, such as a statement of a desire or interest (e.g., “I'm interested in new models of digital cameras”), or as a status update that implies the query (e.g., “I'm moving to New York City and have to start looking for an apartment,” as an implied solicitation of offers for residential rental units that may be available in the specified area).

Additionally, the user may seek responses from many sources of information, and, accordingly, may publish these queries in many types of ways. As a first example, the user may submit the query to an automated search engine, such as a general web search engine that may identify websites and web pages related to the topics discussed in the query, an e-commerce website that may offer a list of products and/or services that may relate to the topics discussed in the query, or a reviews database that may contain reviews of products and/or services, comparisons among the products or services within a particular area, and/or recommendations of products or services for particular circumstances. However, for some queries, an automated search engine may fail to provide information comprising a response that is relevant to the query. For example, the query may involve a large set of details regarding a specific set of circumstances of the user (e.g., “what inexpensive digital camera works well underwater in low-light conditions?”), may be difficult to specify as an automatically parsed natural-language query (e.g., “I′d like to find someone who can fix my computer, but I can't explain what it is doing wrong”), and/or may simply not relate to any of the indexed search results (e.g., a query seeking a copy of an album by an obscure musical band). Alternatively, the user may instead submit the query to a group of individuals, such as the members of a web forum, a group of experts in the topics relating to the query, or a set of personal contacts who may be included in a mass email message. The evaluation of the query by these individuals may yield more relevant and contextually aware results than the search results provided by a search engine. The user may also engage in a multitude of searches to solicit responses to the query (e.g., submitting the query to several search engines and for review by several groups of individuals), and may review all of the responses in order to choose a result.

Also within the field of computing, many scenarios involve a social network, comprising a set of users who may establish associations thereamong (representing various types of relationships, e.g., familial, friendship, acquaintanceship, academic, and professional), and who may share data items with other users or social groups of users. A user may generate a social profile, such as a set of information that describes the demographic information, history, skills, interests of the user, and may choose to share some or all of the social profile with other users. In many such social networks, a user may post a private message to one or more select users, such as an associated user who has an association with the user or the members of a particular social group, and/or a public message (such as a personal status) that may be readable by all associated users who have an association with the user. The user may also choose to share particular items of information and data objects (such as images, videos, files, and references to other resources, such as uniform resource identifiers (URIs) of interested resources that may be accessible via the internet) with one or more other users, and to examine the information and data objects shared with the user by other users. In this manner, the user may communicate and share information and resources with other users, and may establish a social identity and relationships with other users within the social network.

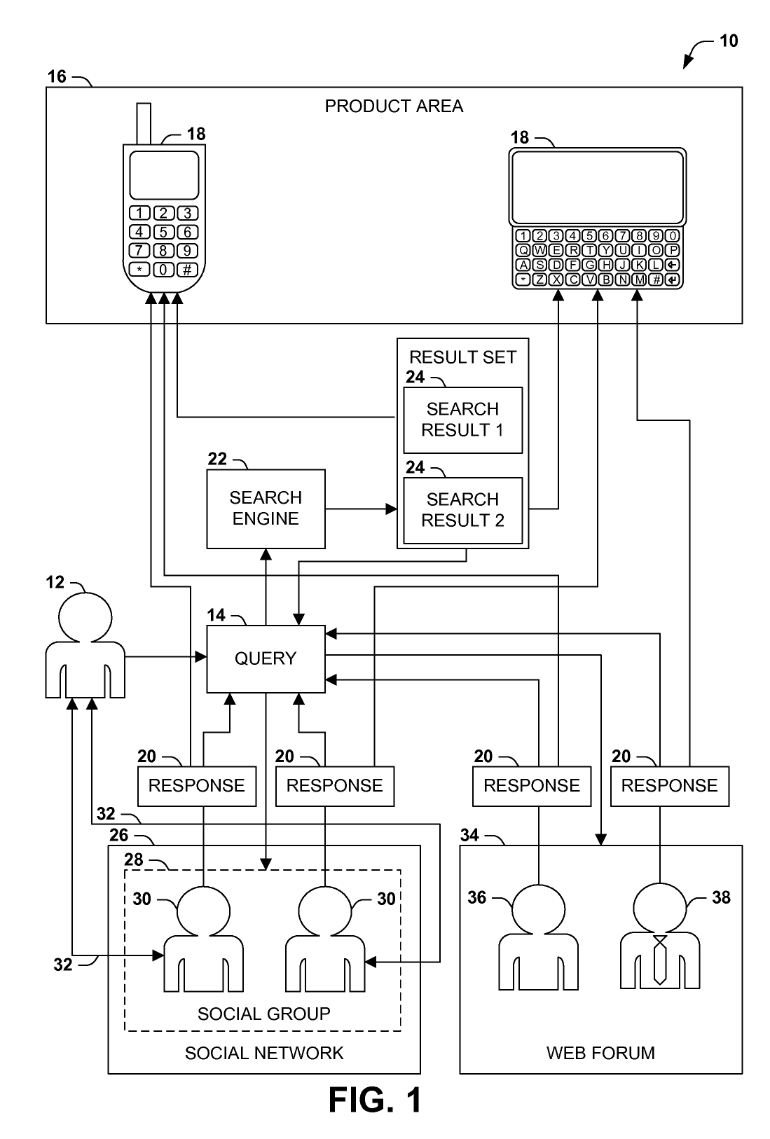

FIG. 1 presents an illustration of an exemplary scenario 10 featuring a user 12 who wishes to receive information about a product area 16 comprising one or more products 18 (such as a recommendation of a product 18 in the product area 16 based on the circumstances of the user 12) by generating a query 14 (e.g., “can someone recommend a mobile device for me?”) In order to receive a broad set of responses 20 informing the user 12 about the product area 16, the user 12 may submit the query 14 to several information sources. As a first example, the user 12 may submit the query 14 to a search engine 22, which may automatically examine a set of indexed search results 24 (e.g., a set of web pages retrieved and evaluated from various websites accessible via the internet), and may return a set of search results 24 comprising references to web pages that respectively present information about one or more products 18 in the product area 16. As a second example, the user 12 may submit the query 14 to a social network 26, and in particular to a social group 28 comprising a set of associated users 30 who respectively have an association 32 with the user 12 (e.g., a defined relationship). The associated users 30 of the social group 28 of the social network 26 may read and consider the query 14, and may provide one or more responses 20 thereto, such as recommendations, user reviews, or product comparisons of one or more products 18 in the product area 16. As a third example, the user 12 may submit the query 14 to a web forum 34, where various members 36 of the web forum 34 may read and consider the query 14 and may provide one or more responses 20 relating to the products 18 of the product area 16. The user 12 may receive and review all of the responses 20 and the search results 24 in order to make a decision regarding a commercial transaction (such as the purchase of a product 18) to be undertaken with respect to the product area 16.

While the user 12 in the exemplary scenario 10 of FIG. 1 may receive a considerable amount of useful information in response to the query 14, some problems may arise with the information so provided. As a first example, the search results 24 provided by the search engine 22 may be impersonal, and the information provided by the search results 24 may not be fully relevant in view of the circumstances of the user 12 and/or the details of the query 14. For example, the user 12 may wish to identify a product 18 having specific characteristics (such as a piece of furniture having a particular size, color, and visual style), but the search engine 22 may be unable to understand the semantic details of the query 14 and/or to locate search results that particularly apply to these characteristics. As a second example, the associated users 30 of the user 12 may be able to provide responses 20 that specifically apply to the details of the user 12, but may not be fully knowledgeable about the product area 16 or one or more products 18 therein. Accordingly, the responses 20 may be incorrect, incomplete, or subjective, and may mislead the user 12 in choosing a particular product 18 when another product 18 in the product area 16 may have been of greater value to the user 12.

As a third exemplary problem in the exemplary scenario 10 of FIG. 1, the members 36 of the web forum 34 may include users who are knowledgeable about the product area 16, may fully understand the semantic details of the query 14, and may provide responses 20 that are both knowledgeable and specific to the circumstances of the user 12. However, in some such scenarios, one or more members 36 may provide inaccurate information. For example, a particular member 36 of the web forum 34 may be employed as an representative 38 of a vendor of a product 18 in the product area 16, and may provide a response 20 comprising incorrect, incomplete, or subjective information about the product 18 in order to persuade the user 12 to purchase the product 18, resulting in a sales commission for the representative 38. Alternatively, the representative 38 may provide an impersonal response 20 (such as a product advertisement for the product 18). While such responses 20 may persuade few users 12, the effort of the representative 38 in posting such responses 20 may be trivial, and even a low response rate may yield a profit for the representative 38 (e.g., in a similar business model as the delivery of unsolicited bulk email messages, or “spam”). Moreover, this representative 38 may fail to disclose the relationship with the vendor of the product, and the user 12 may be unable to determine the association of the representative 38 with the vendor. Therefore, the responses 20 provided by the members 36 of the web forum 34 may be unreliable.

In addition to these problems, the experience of the user 12 in seeking both specific and reliable responses 20 to the query 14 may be poor. The user 12 may have to submit the query 14 to many sources, and the responses 20 and search results 24 received therefrom may be of low average quality, reliability, or relevance to the characteristics of the user 12 and/or the query 14. The user 12 may also receive a large number of responses 20 (e.g., representatives 38 of the vendors of many products 18 in the product area 16 may “spam” the user 12 with impersonal advertisements upon detecting the interest of the user 12 in the product area 16), and determining the relevance and reliability of each response 20 may be time-consuming, frustrating, and difficult.

As another consideration of the exemplary scenario 10 of FIG. 1, various individuals who wish to participate in the provision of information to the user 12 may have difficulty doing so. As a first example, if the volume of queries 14 submitted by various users 12 is large, it may be difficult for a knowledgeable individual to locate queries 14 to which the individual may capably reply. As a second example, specific, reliable, and accurate responses 20 to the query 14 (such as provided by a representative 38 of a vendor of a product 18 who wishes to provide objective, accurate, and valuable information to the user 12) may be lost among a large number of less valuable responses 20 and search results 24. For example, the individual may comprise a knowledgeable salesman who can recommend a product or service that fits very closely with the details of the user 12 and/or the query 14, but if the response 20 of the salesman may be included in a large number of less valuable responses 20, the potential reward to the salesman (such as the probability of a commission from a sale to the user 12 resulting from the response 20) may be insufficient to cover the cost to the salesman in generating the specific response 20 (e.g., the “response cost”).

As yet another consideration of the exemplary scenario 10 of FIG. 1, the various systems that the user 12 accesses in pursuit of responses 20 to the query 14, such as the search engine 22, social network 26, and the web forum 34, may each be provided by one or more comparatively sophisticated device (such as a server or a set of servers), and the acquisition, operation, maintenance, and administration of such devices may entail fees borne by the administrators of the devices. It may be desirable for the administrators to recover some these costs while providing respective services with respect to the query 14 (e.g., identifying and providing the search results 24, exposing the social network 26 to the user 12, and/or hosting the query 14 and responses 20 as a conversation within the web forum 24.) However, the exemplary scenario 10 of FIG. 1 does not present a direct opportunity for recovering the expenses from any of the parties listed herein. The administrators of such systems might rely on advertising, such as by presenting targeted advertisements for the products 18 of the product area 16 while providing the search results 24 and/or responses 20 to the user 12, and by charging advertising fees to the vendors for the presentation of such advertisements. However, these advertisements may not helpfully relate to the query 14, and may further degrade the experience of the user 12 by adding to the amount of irrelevant information presented in response to the query 14.

In view of these considerations, systems may be devised to facilitate the solicitation of responses 20 to a query 14 relating to a commercial transaction. Such systems may be devised to facilitate the matching of the query 14 with agents who are capable of providing knowledgeable and accurate information in view of the particular details of the user 12 and/or the query 14, and in particular may encourage agents to provide high-quality responses 20 in response to a query 14, such as responses 20 that are accurate, complete, timely, and highly relevant to the details of the user 12 and/or the query 14. These results may be achieved by establishing a target number of responses 20 to the query 14 that may be desirable to present to the user 12, and may endeavor to select, from among the agents of an agent set, a set of responders to whom the query is presented 14. This selection may also consider the response probability of each agent in generating a response (e.g., if a target number of six responses is selected, and if each agent may have a 66% chance of choosing to respond to the query 14, the query 14 may be presented to nine agents.) Moreover, the system may establish a pricing model that charges agents for the opportunity to respond to a query 14 according to various factors, including a predicted relevance to the query 14 of a response 20 that may generated by the agent. The inclusion of agent fees may encourage agents to be selective in choosing to respond to particular queries 14 (as opposed to simply “spamming” various queries 14 with low-quality and impersonal responses 20), and to generate high-quality responses 20 that may have an improved relevance and persuasiveness to the user 12.

Systems based on these techniques may present particular advantages to all parties in this scenario. For example, the pricing system may encourage agents to be selective in choosing queries 14 for responses, and in drafting responses 20 of high relevance to the query 14 and persuasiveness to the user 12, in order to achieve a high rate of return on the authoring of such responses 20 (such as a high percentage of commissions arising from commercial transactions resulting from such responses 20), and may also promote the visibility of such responses 20 to the user 12 by limiting the number of lower-quality responses 20 received from other agents (e.g., by reducing the “spam” problem that often arises in such systems.) The user 12 may benefit from receiving a small number of responses that are highly relevant 20 from the agents, and by utilizing a single source of high-quality information instead of having to submit the query 14 to several systems and to review the responses 20 and search results 24 of each source. Additionally, the administrators of the system may use the response fees received from the agents to cover the operating and administrative costs of the system. In this manner, a system configured to select agents for a particular query, and to apply the pricing model described herein, may promote the interests of all parties involved in the submission of the query 14 and the solicitation and presentation of responses 20.

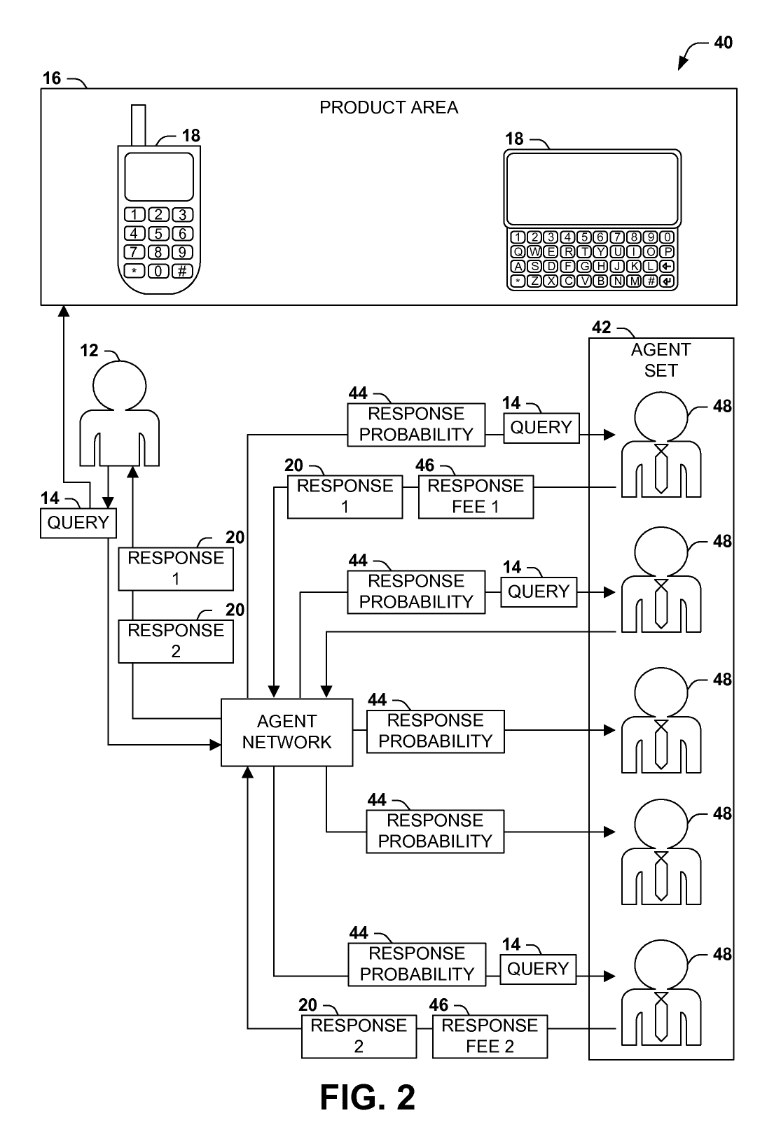

FIG. 2 presents an illustration of an exemplary scenario 40 implementing some of the techniques presented herein. In this exemplary scenario 40, a user 12 may express an interest in a particular product area 16 comprising a set of products 18 by generating a query 14. In contrast with the exemplary scenario 10 of FIG. 1, the user 12 may choose to submit the query 14 to a system configured according to the techniques presented herein, such as an agent network that is connected to an agent set 42, comprising a set of agents 48 who may be capable of providing response that are relevant 20 to various queries 14 (e.g., a set of representatives of various vendors, or a set of experts regarding various products 18 and/or product areas 20.) Upon receiving the query 14, the agent network may first identify a subset of agents 48 who may be capable of providing a response that is relevant 20 to the query 14. This determination may be based on an estimation, for each agent 48, of a response probability 44 indicating the probability that the agent 48 may respond to the query 14 (e.g., by comparing the nature of the query 14, such as the topics discussed, with the skills and knowledge areas of respective agents 48.) The selection may also be sensitive to the reported response costs of the respective agents 48 in determining whether to evaluate a query 14; e.g., an agent 48 with a high reported response cost of generating a response 20 to a query 14 may be offered the query 14 only if a high degree of overlap exists between the skills of the agent 48 and the subject of the query 14, whereas an agent 48 with a low reported response cost of generating a response 20 to a query 14 may be offered a wide range of queries 14 for responses 20. Upon selecting one or more agents 48, the agent network may offer the query 14 to these agents 48, along with a quote of a response fee 46 to be charged to the responder if the agent 48 chooses to provide a response 20. Each responder may evaluate the offer of the query 14 and the response fee 46, and may decide whether or not to generate a response 20. For those who choose to generate a response 20, the agent network may accept the response 20, present it to the user 12, and charge the response fee 46 to the agent 48.

As illustrated in the exemplary scenario 40 of FIG. 2, the agent network may, upon receiving the query 14, evaluate the response probabilities 44 of respective agents 48 in view of the details of the query 14 and/or the user 12. The agent network may also adjust this selection based on the number of responses 20 that may desirably be presented to the user 12 in response to the query 14 (e.g., if two responses 20 are desired, and if each agent 48 has a 66% chance of providing a response 20, the agent network may endeavor to select a total of three agents 48.) The agent network therefore selects three agents 48, and offers the query 14 to each agent 48, along with a quote of the agent fee 46 to be charged to the agent 48 in exchange for accepting a response 20. Accordingly, two of the agents 48 may generate and send to the agent network a response 20 to the query 14, while the third agent 48 may choose not to respond (e.g., if the query 14 is not suitably relevant to the knowledge and interests of the agent 48). The agent network may then present the two responses 20 to the user 12, and may charge the quoted response fees 46 to the respective agents 48. In this manner, the agent network may elicit highly relevant and selective responses 20 to the query 14 from the agents 48, may promote the effectiveness of responses 20 generated by a particular agent 48, and may achieve a sponsorship of the costs of the administrative and operating costs of the agent network derived from the agents 48 by utilizing the techniques presented herein.

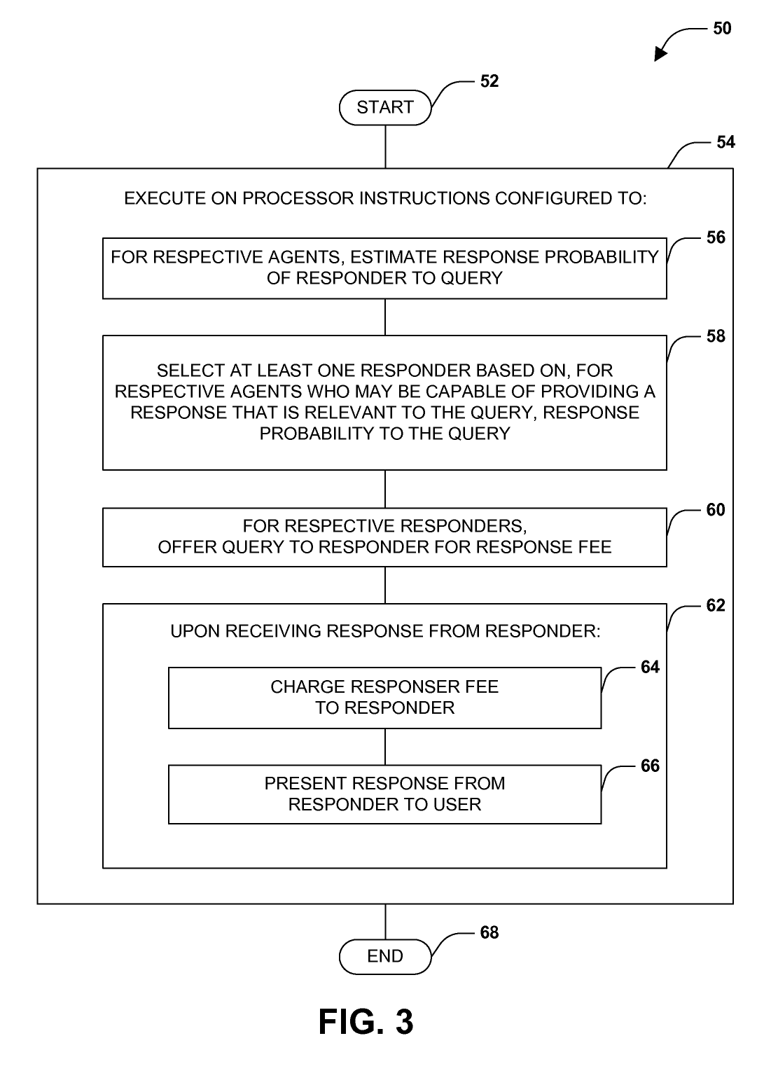

FIG. 3 presents a first embodiment of these techniques, illustrated as an exemplary method 50 of eliciting at least one response 20 to a query 14 of a user 12 from at least one agent 48 of an agent set 42. The exemplary method 50 may be implemented, e.g., as a set of software instructions stored in a memory component (such as system memory, a hard disk drive, a solid-state storage device, or a magnetic or optical disc) of a device having a processor. The exemplary method 50 begins at 52 and involves executing 54 on the processor instructions configured to perform the techniques presented herein. In particular, the instructions are configured to, for respective agents 48, estimate 56 a response probability 44 of the agent 48 to the query 14, and select 58 at least one responder 48 based on, for respective agents 48 who may be capable of providing a response 20 that is relevant to the query 14, the response probability 44 to the query 14. The instructions are also configured to, for respective responders, offer 60 the query 14 to the responder in exchange for a response fee 46. The instructions are also configured to, upon receiving 62 a response 20 from a responder, charge 64 the response fee 46 to the responder, and present 66 the response 20 from the responder to the user 12. In this manner, the exemplary method 60 achieves the eliciting, receipt, and presentation of responses 20 to the query 14 on behalf of the user 12, and so ends at 68.

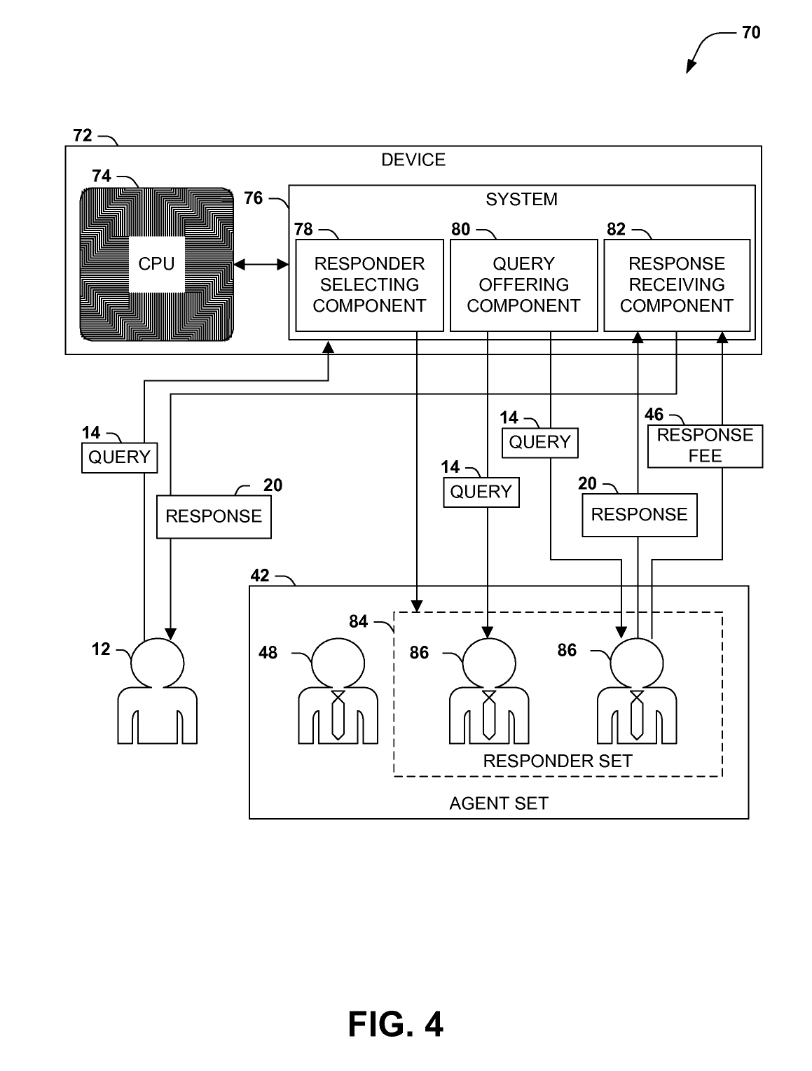

FIG. 4 presents a second embodiment of these techniques, illustrated as an exemplary system 76 configured to elicit responses 20 to a query 14 of a user 12 from at least one agent 48 of an agent set 42. The exemplary system 76 may be executed, e.g., on a device 72, such as a server positioned in the role of the agent network in the exemplary scenario 40 of FIG. 2, and configured to receive one or more queries 14 from various users 12 and to elicit responses 20 thereto from the agents 48 of an agent set 84. The exemplary system 76 may comprise, e.g., a software architecture comprising a set of interoperating components, each implemented as a set of instructions stored in a memory of the device 72 and that, when executed on a processor 74 of the device, interoperate with the other components of the software architecture to perform the techniques presented herein. In particular, the exemplary system 76 comprises an agent selecting component 78, which is configured to, for respective agents 48, estimate a response probability 44 of the agent 48 to a query 14, and to select from among the agents 48 at least one responder 86 based on, for respective agents 48 who may be capable of providing a response 20 that is relevant to the query 14, the response probability 44 of the agent 48 in generating a response 20 for the query 14. The exemplary system 76 also includes a query offering component 80, which is configured to, for respective responders 86, offer the query 14 to the responder 86 in exchange for a response fee 46. The exemplary system 76 also includes a response receiving component 82, which is configured to, upon receiving a response 20 from a responder 86, charge the response fee 46 to the responder 86, and present the response 20 from the responder 86 to the user 14. In this manner, the individual components of the software architecture illustrated in the exemplary scenario 70 of FIG. 4 interoperate to elicit responses 20 from various agents 48 to queries 14 submitted by users 12 in accordance with the techniques presented herein.

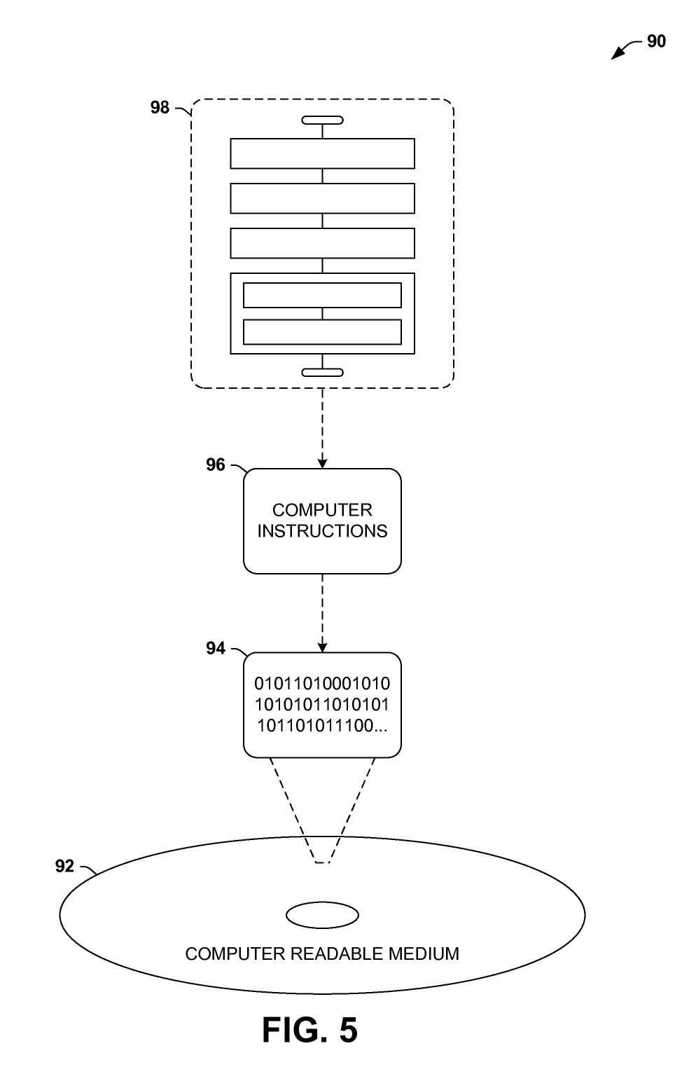

Still another embodiment involves a computer-readable medium comprising processor-executable instructions configured to apply the techniques presented herein. An exemplary computer-readable medium that may be devised in these ways is illustrated in FIG. 5, wherein the implementation 90 comprises a computer-readable medium 92 (e.g., a CD-R, DVD-R, or a platter of a hard disk drive), on which is encoded computer-readable data 94. This computer-readable data 94 in turn comprises a set of computer instructions 96 configured to operate according to the principles set forth herein. In one such embodiment, the processor-executable instructions 96 may be configured to perform a method of eliciting at least one response to a query of a user from at least one agent of an agent set, such as the exemplary method 50 of FIG. 3. In another such embodiment, the processor-executable instructions 96 may be configured to implement a system for eliciting at least one response to a query of a user from at least one agent of an agent set, such as the exemplary system 76 of FIG. 4. Some embodiments of this computer-readable medium may comprise a non-transitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 50 of FIG. 3 and the exemplary system 76 of FIG. 4) to confer individual and/or synergistic advantages upon such embodiments.

A first aspect that may vary among embodiments of these techniques relates to the scenarios wherein such techniques may be utilized. As a first example, these techniques may be utilized to receive many types of queries 14, such as queries 14 about specific products 18, product areas 16, recommendations for products 18 or comparisons among two or more products 18, or details about particular characteristics of a product 18 (e.g., availability, features, and/or compatibility with other products 18.) The term “product” as used herein also includes a service that may be offered by a service provider. As a second example of this first aspect, an embodiment of these techniques may utilize many types of communication to present the query 14 to a responder 86 and/or to present a response 20 to the user 12, such as email, a chat service, a web forum, or a messaging system in a network (such as a social network).

As a third example of this first aspect, these techniques may be utilized to elicit responses 20 from many types of agents 48, such as representatives of vendors of particular products 18 or independent experts in a particular product 18 or product area 16. Vendors and their representatives may be compensated for participating in these scenarios (and may be more highly compensated for providing more highly relevant and valuable responses 20) through the persuasive effects of their responses 20 upon the user 12 and the possibility of the completion of a commercial transaction with the user 12, which may yield a profit for the vendor and/or a commission for the representative. However, at least one of the agents 46 may comprise an independent agent who is knowledgeable in areas related to the query 12, but who is not affiliated with any vendor, manufacturer, or product 18. It may be desirable to encourage these independent agents 46 to participate in the agent network, particularly because such agents 46 may be more likely to submit unbiased opinions of a product area 16. However, independent agents 46 may be particularly benefit from the influence of the response 20 on the user 12 (particularly if such agents 48 pay to submit the responses 20). These agents 48 may be encouraged to participate in the agent network (and to pay for the submission of responses 20) by, upon detecting a completion of a transaction by a user 12 resulting from a response 20 to the query 14 received from a particular responder 86, awarding the responder 86 with a commission. This commission may be provided, e.g., directly from the agent network, or may be provided from a vendor of a product 18 involved in the commercial transaction. Those of ordinary skill in the art may devise many scenarios wherein the techniques presented herein may be advantageously utilized.

A second aspect that may vary among embodiments of these techniques relates to the manner of estimating the response probabilities 44 to a query 14 from various agents 48. As a first example, the response probabilities 44 may be estimated based on historical data, e.g., the rates of responses 20 received from the respective agents 48 in response to previously offered queries 14. As a second example of this second aspect, the response probabilities 44 may be estimated based on the perceived relevance of the query 14 to the interests of the respective agents 48; e.g., an agent 48 comprising a representative of a vendor of products 18 may have a higher estimated response probability 44 to a query 14 indicating that the user 12 is interested in the products of the vendor than to a query 14 indicating that the user 12 is not interested in the products of the vendor or is not ready to purchase a product 18. As a third example of this second aspect, the response probabilities 44 may be estimated based on an identification of the knowledge set of the respective agents 48 and a degree of matching with one or more topics associated with the query 14. As a fourth example of this second aspect, many prediction techniques may be used to match the data about an agent 48 with the details of a query 14 in order to estimate the response probability. Many statistical techniques, such as Bayesian classifiers, may be utilized in this context, as well as various learning techniques, such as various forms of artificial neural networks, genetic algorithms, or expert systems, that have been trained to estimate response probabilities 44 of various agents 48 with various queries 14. Such learning components might also be utilized, e.g., to improve the selection of associated users 30 within a social network 26 by identifying selected associated users 30 who may be capable of providing responses 20 that are highly relevant to the query 14, and of limiting the presentation of the query 14 to such selected associated users.

Those of ordinary skill in the art may devise many ways of predicting the response probabilities 44 for various agents 48 and queries 14 while implementing the techniques presented herein.

A third aspect that may vary among embodiments of these techniques relates to the manner of selecting, from an agent set 42, one or more responders 86 to whom a query 14 received from a user 12 may be offered. As a first example, the selection of responders 86 from the agent set 42 may be based on a target response count of responses 20 to the query 14 that are desirably received from the responders 86. For example, if a target response count of six responses 20 is specified (e.g., by the agent network, or by the user 12), a sufficient number of agents 48 may be selected that are estimated to generate six responses 20 (e.g., by selecting a responder set 84 where the response probabilities 44 of the responders 86 sum to at least 6.0.)

As a second example of this third aspect, several other forms of data may be utilized (in conjunction with the respective estimated response probabilities 44) in the selection of responders 86 from the agent set 42. In a first such variation, the selection of responders 86 may take into account a response cost, such as a reported cost of a responder 86 in order to evaluate and generate a response 20 to a query 14. For example, for a first agent 48 may be a highly skilled salesman whose time is comparatively valuable, a proportionally high response cost may be designated; and for a second agent 48 who is capable of evaluating many queries 14 and generating responses 14 efficiently (e.g., through the use of filtering techniques to select queries 14 of high relevance to the second agent 48), a low or even zero response cost may be designated. These response costs may then be considered while selecting responders 86 from the agent set 42, such that agents 48 having a comparatively high response cost may be selected as responders 86 at a high level of selectivity (e.g., for queries 14 that closely match the knowledge set of the agent 48), while agents 48 having a comparatively low response cost may be selected as responders 86 at a low level of selectivity (e.g., for queries 14 that even loosely match the knowledge set of the agent 48.)

As a second variation of this second example of this third aspect, the selection of responders 86 from the agents 48 of an agent set 42 may include an estimation of a response relevance to the query 14 of a response 20 that may be received from the responder 86. For example, the knowledge sets and comparative expertise of respective agents 48 may be tracked. An agent 48 having a high level of specific knowledge regarding several of the topics associated with a query 14 may be estimated as capable of generating a highly relevant response 20, while an agent 48 having a lower level of specific knowledge, or only a general knowledge, regarding some of the topics associated with a query 14 may be estimated as capable of generating less relevant responses 20. Accordingly, responders 86 may be selected from the agents 48 of the agent set 42 according to the relevance of such responses 20 to the details of the query 14.

As a third variation of this second example of this third aspect, the selection of responders 86 from among the agents 48 of the agent set 42 may be based in part on a response bid received from the agent 48 for responding to respective queries 14. For example, a first agent 48 may endeavor to embark on a broad marketing campaign for a product 18, and may offer (e.g., to an agent network that is configured to select responders 86) a higher response bid in order to secure priority in the selection of the first agent 48 for receiving offers to respond to various queries 14, while a second agent 48 may not be as adamant to receive many queries 14 and may specify a lower response bid. The respective response bids received from various agents 48 may be considered while selecting agents 48 for inclusion in the responder set 84. Moreover, an agent 48 may specify a range of response bids associated with different query types. For example, a first query type may include queries 14 that are associated with a product area 16; a second query type may include queries 14 that are associated with products 18 having a specific feature; and a third query type may include queries 14 that relate to a specific product 18. Because these different query types may indicate different levels of potential interest of the user 12 in a particular product 18, an agent 48 may specify different response bids for different query types, and the selection of responders 86 from among the agents 48 of the agent set 42 may be based in part on the response bids of the respective agents 48 for the query type of the query 14.

As a third example of this third aspect, as with the prediction of the response probabilities 44 of various agents 48, the prediction of other relevant data (such as response relevance) may utilize one or more of many available prediction techniques, including both statistical techniques (e.g., Bayesian classifiers) and various learning techniques (e.g., various forms of artificial neural networks, genetic algorithms, and expert systems). These learning techniques may be trained using a training data set, such as a sample set of agents 48 having various properties and some information about the predictable behavior thereof (e.g., the rates with which an agent 48 represented in the training set may respond to a query 14, and/or may generate a response 20 that is relevant to the query 14.)

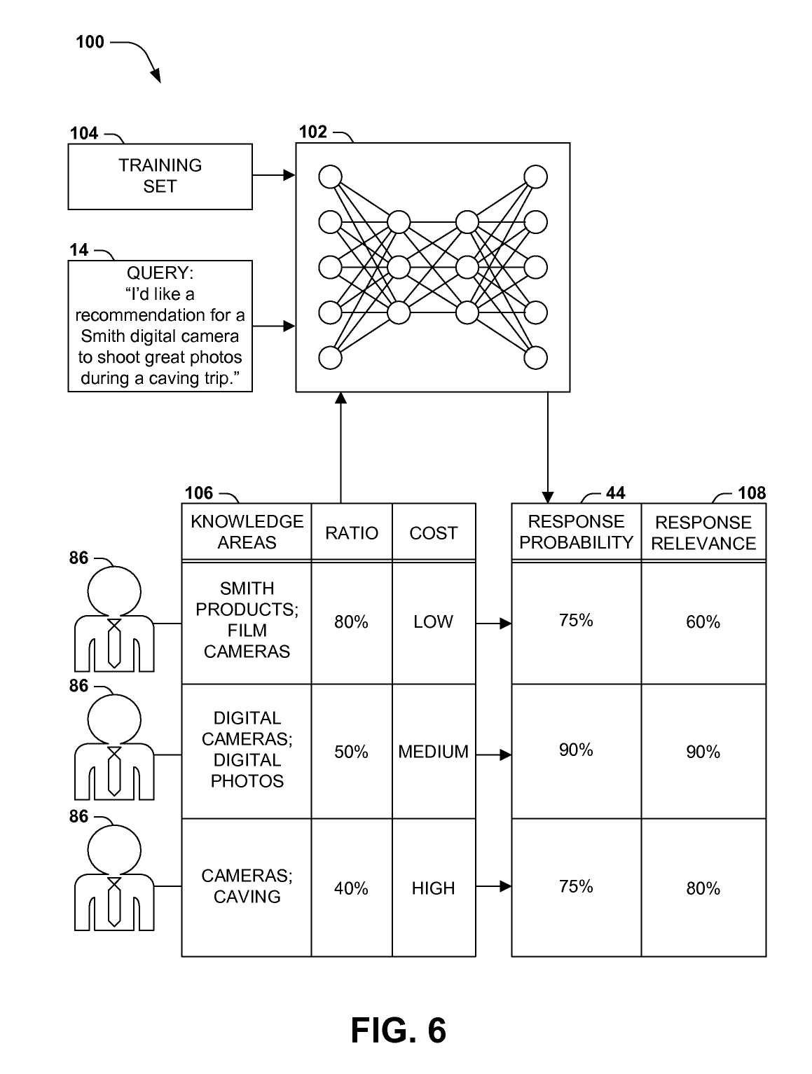

FIG. 6 presents an illustration of an exemplary scenario 100 featuring a learning component 102, depicted herein as a neural network. The learning component 102 is trained using a training set 104, such as a training query set comprising various training queries that may serve to orient the internal logic of the learning component 102 to predict various aspects of queries 14 and/or agents 48 with a high degree of confidence. In this exemplary scenario 100, the training set 104 is utilized to achieve a mapping of various traits of an agent 48 (e.g., the knowledge areas 106 of the agent 48) with a response probability 44 and a response relevance 108 in view of a particular query 14. Accordingly, an embodiment of these techniques may be configured to, using the training query set, train the learning component 102 to estimate, for respective responders 86 and for respective training queries of the training query set, the response probability 44 and the response relevance 108 of the responder 86 to the training query. Once this training is complete, the learning component 102 may be invoked to estimate the response probability 44 and response relevance 108 for respective real-world responders 86 in view of a real-world query 14. In this manner, a prediction of response probabilities 44 and/or response relevance 108 of a response 20 submitted by a responder 84 for presentation to the user 12 in reply to the query 14 may be achieved, and this information may then be used in the selection of responders 86 from among the agents 48 of the agent set 42. Those of ordinary skill in the art may devise many ways of selecting responders 86 from the agents 48 of the agent set 42 while implementing the techniques presented herein.

A fourth aspect that may vary among embodiments of these techniques relates to the manner of computing the response fee 46 to be charged to a responder 86 in exchange for accepting a response 20 to be presented to the user 12. As a first example, the response fee 46 may simply be designated as a flat fee for any responder 86, or as a per-agent flat fee for each agent 48 as a responder 86. Alternatively, the response fee 46 may be adjusted, based on many factors, to adjust the effects of the pricing model on various responders 86. For example, the agents 48 may be permitted to specify a response bid for respective queries 84, which may affect the selection of responders 86 from the agent set 42 and may be factored into the response fee 46 charged to a responder 86 for a response 20. For example, in the selection of responders 86, a first agent 48 entering a higher response bid (and offering to pay a higher response fee 46) may receive a higher priority than a second agent 48 entering a lower response bid, and may therefore be offered a broader set of queries 14 than the second agent 48. As another example, where various agents 48 report a response cost associated with evaluating a query 14 and generating a response 20 thereto, the response fee 46 for a particular response 20 may be adjusted based on the response cost, e.g., by deducting the response cost from the response fee 46 charged to the responder 86 in exchange for the response 20. This adjustment may be advantageous, e.g., for reducing the effect of variable response costs on the selection of responders 86 among the agents 48, in order to focus the selection of responders 86 more acutely on the response relevance of the generated responses 20. (For example, by including this discounting, an agent 48 capable of generating a response 20 by a first agent 48 that is predicted as having a higher response relevance to a particular query 14 may be selected as a responder 86 over a second agent 48 that is capable only of providing a response 20 having a lower response relevance, even if the response cost of the first agent 48 is higher than the response cost of the second agent 48.) As yet another example, the response fee 46 may be adjusted based on the promptness of the response 20; e.g., if the query 14 is received from the user 12 at a particular query time, and a response 20 is received from a responder 86 at a particular response time elapsing after the query time (e.g., two minutes, two hours, or two days after receiving the query 14), the response fee 48 may be scaled proportionally with respect to the length of the response time in order to encourage responders 86 to submit timely responses 20 to the query 14.

As a second example of this fourth aspect, the response fee 46 may be charged as a single unit, or may comprise multiple smaller charges. For example, in one such formulation, an initial response fee may be charged to a responder 86 upon receiving the query, and if the user 12 is influenced by the response 20 to engage in a commercial transaction, a second fee (e.g., a user interaction response fee) may be charged to the responder 86. This model may reduce the effect of the imposed response fee 46 on the participation of agents 48 by charging a lower response fee 46 if the response 20 does not result in a transaction.

As a third example of this fourth aspect, many ways of computing the response fees 46 for particular responders 86 may be selected. One such computation that may be suitable for computing response fees 46 in some scenarios is represented by the following mathematical formula:

$$Initial Response {Fee}_{{S}_{i}} = \{ \begin{matrix}if {F}_{i} \geq L \text{:} Max ( L , \frac{{c}_{i}}{{P}_{i}} ) \\ if {F}_{i} \geq L \text{:} {F}_{i}\end{matrix} \\ and \\ User Interaction Response {Fee}_{{S}_{i}} = \{ \begin{matrix}if {F}_{i} \geq L \text{:} 0 \\ if {F}_{i} \geq L \text{:} \frac{( L - {F}_{i} )}{{R}_{i}}\end{matrix}$$

According to this mathematical formula:

S represents the agents of the agent set;

Sᵢ represents an agent i in the agent set;

Cᵢ represents an response cost of agent Sᵢ for generating the response to the query;

Pᵢ represents a response probability estimated for receiving a response from agent Sᵢ to the query;

Rᵢ represents a response relevance to the query of the response received from agent Sᵢ; and

Fᵢ represents a base response fee to be charged to agent Sᵢ upon receiving the response to the query, computed according to a mathematical formula, which is, in turn, computed according to the mathematical formula:

$${F}_{i} = Max ( {R}_{i} \times {B}_{i} , \frac{{c}_{i}}{{P}_{i}} )$$

wherein:

Bᵢ represents a bid received from the agent to respond to the query;

N represents a target response count of responses to the query received from the responders; and

L represents F_{N+1}.

However, those of ordinary skill in the art may devise many mathematical formulae, and many other ways of adjusting the response fee 46 charged to a responder 86 in exchange for accepting a response 20 to a query 14, while implementing the techniques presented herein.

A fifth aspect that may vary among embodiments of these techniques relates to the manner of presenting the responses 20 received from the responders 86 to the user 12. As a first example, as each response 20 is received, the user 12 may be promptly notified; alternatively, the responses 20 may be aggregated into a single information source and presented together to the user 12. As a second example of this fifth aspect, a responder 86 may be associated with one or more contact items whereby the user 12 may contact a responder 86 to complete a commercial transaction based on the response 20, and such contact items may be included in the presentation of the response 20 to the user 12. As a third example of this fifth aspect, a responder 86 who is also a vendor of a product 18 (including a service provider of a service) to which the query 14 is related may include an offer relating to the product, such as a discount on a purchase, a trial period, or an offer for free or discounted accessories related to the product, and this offer may be included in the presentation of the response 20 to the user 12.

As a third example of this fifth aspect, responses 20 submitted by various responders 86 may be presented to the user 12 in many ways, such as a discrete set of responses 20 provided by sponsors of the agent network. The responses 20 received from the responders 84 may also be presented alongside other types of response 20, such as search results 24 generated by a search engine 22 or responses 20 received from the members of a social network 26. Alternatively, the responses 20 received from the responders 86 may be integrated with other types of information. For example, where the user 12 has at least one association 32 with at least one associated user 30 within a social network 26, an embodiment may be configured to offer the query 14 to at least one associated user 30, and may present to the user 12 any responses 20 received from associated users 32. In particular, the embodiment may be configured to utilize a similar selection technique for the associated users 30 as for the selection of responders 86, e.g., by selecting for presentation of a query 14 at least one selected associated user who may be capable of providing a response 20 that is relevant to the query 14. Alternatively or additionally, the embodiment may be configured to present the response 20 from the associated user 30 with a visual presentation that is similar to the visual presentation of the responses 20 received from the responders 86, e.g., by integrating the responses 20 received from the responders 86 with those received from the associated users 30.

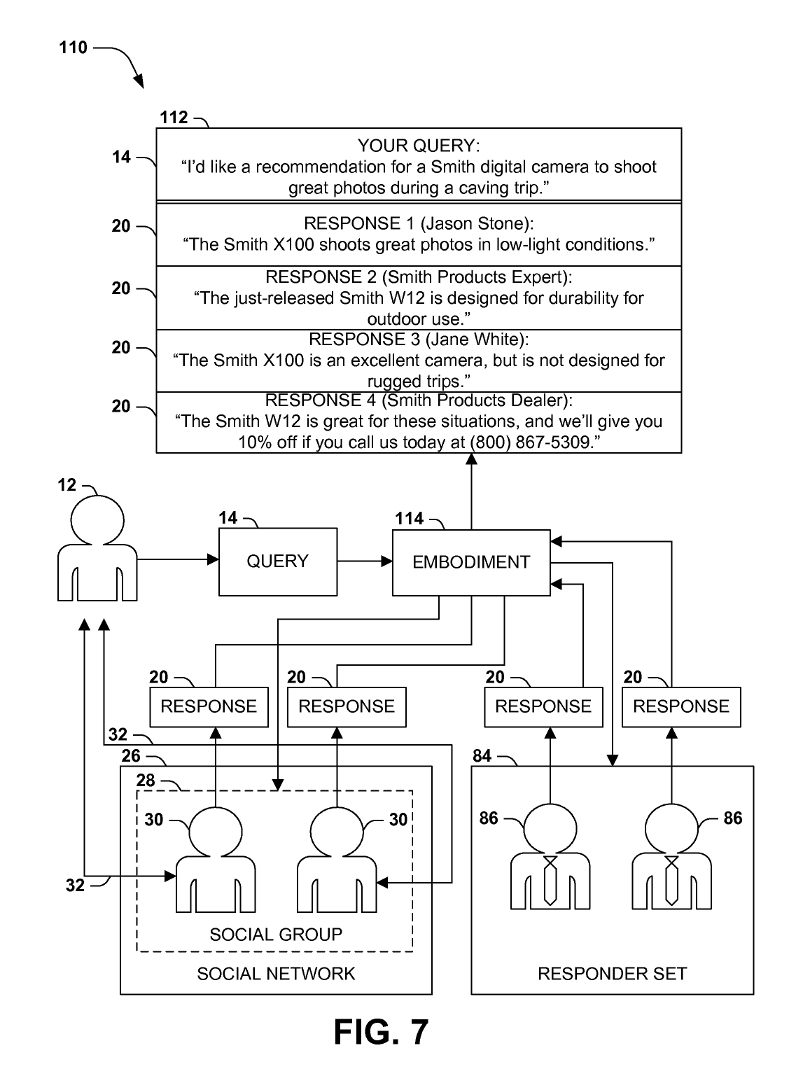

FIG. 7 presents an exemplary scenario 110 featuring a presentation 112 of responses 20 to a query 14 submitted by a user 12. In this exemplary scenario 110, an embodiment of these techniques 114 may receive a query 14 from a user 12, may offer the query 14 to one or more responders 86 of a responder set 84 (selected from among the agents 48 of an agent set 42), and may receive one or more responses 20 therefrom (in exchange for charging a response fee 46 to the respective responders 86). The embodiment 114 may also be configured to submit the response 20 to a social network 26, e.g., to a social group 28 comprising a set of associated users 30 who have an association 32 with the user 12, and may receive one or more responses 20 from such associate users 30. The embodiment 114 may then prepare for the user 12 a presentation 112 of the responses 20 received from the responders 86 and the associated users 30. By generating a presentation 112 including both types of responses 20, the embodiment 114 may present to the user 12 an information set comprising both knowledgeable responses 20 received from experts and product vendors and highly personalized responses 20 received from associated users 30 who may be highly familiar with the characteristics of the user 12. Additionally, in this exemplary scenario 110, the responses 30 from each set of individuals are presented with a similar visual style, such that the type of source (an embodiment-sponsoring, response-fee-paying responder 86 vs. an associated user 30) are difficult to distinguish without examining the name of the individual who submitted the response 20. This similarity of visual style may promote the connotation of the responses 20 received from the responders 86 as reliable information, instead of as advertisements for various products 14. Those of ordinary skill in the art may devise many ways of presenting the responses 20 for a query 14 to a user 12 while implementing the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

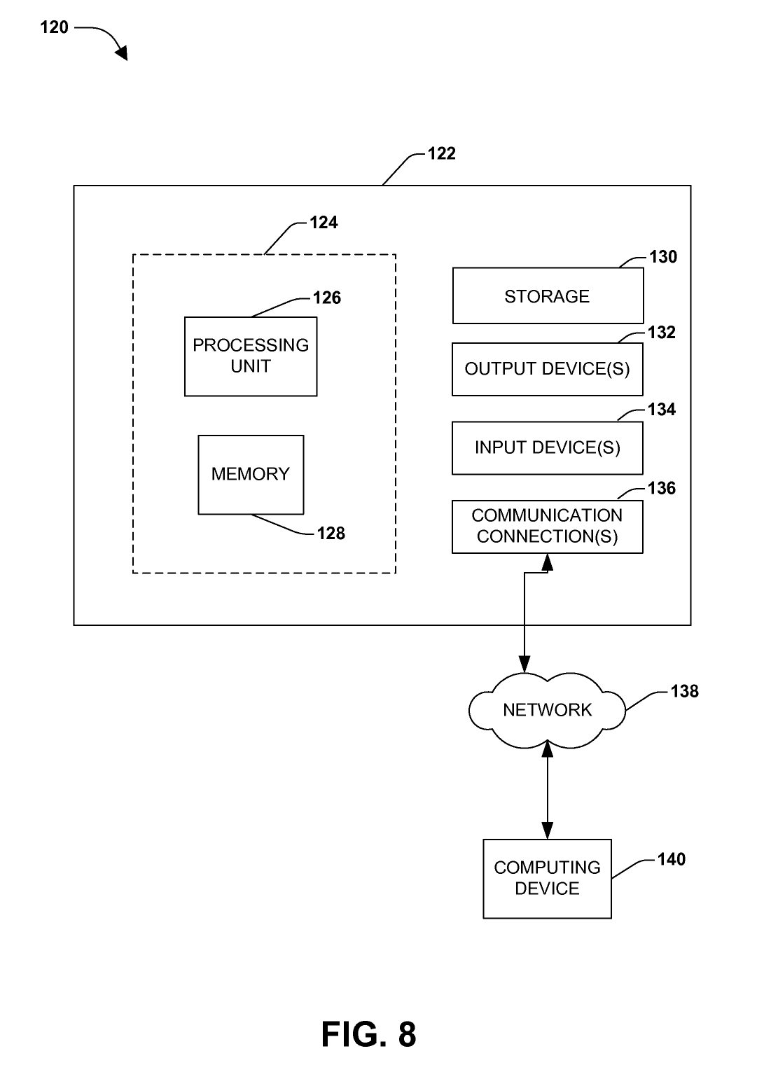

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 120 comprising a computing device 122 configured to implement one or more embodiments provided herein. In one configuration, computing device 122 includes at least one processing unit 126 and memory 128. Depending on the exact configuration and type of computing device, memory 128 may be volatile (such as RAM, for example), non-volatile (such as ROM, flash memory, etc., for example) or some combination of the two. This configuration is illustrated in FIG. 8 by dashed line 124.

In other embodiments, device 122 may include additional features and/or functionality. For example, device 122 may also include additional storage (e.g., removable and/or non-removable) including, but not limited to, magnetic storage, optical storage, and the like. Such additional storage is illustrated in FIG. 8 by storage 130. In one embodiment, computer readable instructions to implement one or more embodiments provided herein may be in storage 130. Storage 130 may also store other computer readable instructions to implement an operating system, an application program, and the like. Computer readable instructions may be loaded in memory 128 for execution by processing unit 126, for example.

The term “computer readable media” as used herein includes computer storage media. Computer storage media includes volatile and nonvolatile, removable and non-removable media implemented in any method or technology for storage of information such as computer readable instructions or other data. Memory 128 and storage 130 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 122. Any such computer storage media may be part of device 122.

Device 122 may also include communication connection(s) 136 that allows device 122 to communicate with other devices. Communication connection(s) 136 may include, but is not limited to, a modem, a Network Interface Card (NIC), an integrated network interface, a radio frequency transmitter/receiver, an infrared port, a USB connection, or other interfaces for connecting computing device 122 to other computing devices. Communication connection(s) 136 may include a wired connection or a wireless connection. Communication connection(s) 136 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 122 may include input device(s) 134 such as keyboard, mouse, pen, voice input device, touch input device, infrared cameras, video input devices, and/or any other input device. Output device(s) 132 such as one or more displays, speakers, printers, and/or any other output device may also be included in device 122. Input device(s) 134 and output device(s) 132 may be connected to device 122 via a wired connection, wireless connection, or any combination thereof. In one embodiment, an input device or an output device from another computing device may be used as input device(s) 134 or output device(s) 132 for computing device 122.

Components of computing device 122 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 122 may be interconnected by a network. For example, memory 128 may be comprised of multiple physical memory units located in different physical locations interconnected by a network.

Those skilled in the art will realize that storage devices utilized to store computer readable instructions may be distributed across a network. For example, a computing device 140 accessible via network 138 may store computer readable instructions to implement one or more embodiments provided herein. Computing device 122 may access computing device 140 and download a part or all of the computer readable instructions for execution. Alternatively, computing device 122 may download pieces of the computer readable instructions, as needed, or some instructions may be executed at computing device 122 and some at computing device 140.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of eliciting at least one response to a query of a user from at least one agent of an agent set on a device having a processor, the method comprising:
executing on the processor instructions configured to:
for respective agents, estimate a response probability of the agent to the query;
select at least one responder based on, for respective agents who may be capable of providing a response that is relevant to the query, the response probability to the query;
for respective responders, offer the query to the responder for a response fee; and
upon receiving a response from a responder:
charge the response fee to the responder, and
present the response from the responder to the user.

2. The method of claim 1:
the user having at least one association with at least one associated user within a social network; and
the instructions configured to:
offer the query to at least one associated user; and
upon receiving a response from an associated user, present the response from the associated user to the user.

3. The method of claim 2:
the instructions configured to select at least one selected associated user who may be capable of providing a response that is relevant to the query; and
offering the query to at least one associated user comprising: offering the query to at least one selected associated user.

4. The method of claim 3:
the instructions configured to train a learning component to select, for respective training queries of a training query set, at least one selected associated user who may be capable of providing a response that is relevant to the training query; and
selecting the at least one selected associated user comprising: invoking the learning component to select at least one selected associated user who may be capable of providing a response that is relevant to the query.

5. The method of claim 2, presenting the response from the associated user comprising: presenting the response from the associated user with a visual presentation similar to the visual presentation of the at least one response from at least one responder.

6. The method of claim 1, selecting the at least one responder comprising: selecting at least one responder based on:
for respective agents, the response probability to the query, and
a target response count of responses to the query that may be received from the responders.

7. The method of claim 1:
at least one agent specifying an response cost for the agent in generating a response to a query; and
selecting the at least one responder comprising: selecting at least one responder based on, for respective agents, the response probability to the query and the response cost.

8. The method of claim 7, charging the response fee to the responder comprising: charging to the responder the response fee discounted by the response cost.

9. The method of claim 1:
the instructions configured to, for respective agents, estimate a response relevance to the query of a response from the agent; and
selecting the at least one responder comprising: select at least one responder based on, for respective agents, the response probability to the query and the response relevance of a response from the agent to the query.

10. The method of claim 9:
the instructions configured to train a learning component to estimate, for respective agents and for respective training queries of a training query set, the response probability and the response relevance of the agent to the training query;
estimating the response probability to the query comprising: invoking the learning component to estimate the response probability of respective agents to the query; and
estimating the response relevance to the query comprising: invoking the learning component to estimate the response relevance of respective agents to the query.

11. The method of claim 1:
at least one agent submitting a response bid for respective queries;
selecting the at least one responder comprising: selecting at least one responder based on, for respective agents, the response probability for the query and the response bid; and
charging the response fee to a responder comprising: charging to the responder a response fee including the response bid.

12. The method of claim 11:
the query having a query type;
at least one agent submitting at least one query type response bid for queries of respective query types;
selecting the at least one responder comprising: selecting at least one responder based on, for respective agents, the response probability for the query and the query type response bid for the query type of the query; and
charging the response fee to a responder comprising: charging to the responder a response fee including the query type response bid for the query type of the query.

13. The method of claim 1:
the query received from the user at a query time;
the responses from respective responders received at a response time elapsing after the query time; and
charging the response fee to the responder comprising: charging to the responder the response fee adjusted based on a response time.

14. The method of claim 1, the response fee charged to a responder comprising an initial response fee and a user interaction response fee calculated according to a mathematical formula comprising:
$$Initial Response {Fee}_{{S}_{i}} = \{ \begin{matrix}if {F}_{i} \geq L \text{:} Max ( L , \frac{{c}_{i}}{{P}_{i}} ) \\ if {F}_{i} \geq L \text{:} {F}_{i}\end{matrix} \\ and \\ User Interaction Response {Fee}_{{S}_{i}} = \{ \begin{matrix}if {F}_{i} \geq L \text{:} 0 \\ if {F}_{i} \geq L \text{:} \frac{( L - {F}_{i} )}{{R}_{i}}\end{matrix}$$
wherein:
S represents the agents of the agent set;
Sᵢ represents an agent i in the agent set;
Cᵢ represents an response cost of agent Sᵢ for generating the response to the query;
Pᵢ represents a response probability estimated for receiving a response from agent Sᵢ to the query;
Rᵢ represents a response relevance to the query of the response received from agent Sᵢ;
Fᵢ represents a base response fee to be charged to agent Sᵢ upon receiving the response to the query, computed according to a mathematical formula:
$${F}_{i} = Max ( {R}_{i} \times {B}_{i} , \frac{{c}_{i}}{{P}_{i}} )$$
wherein:
Bᵢ represents a bid received from the agent to respond to the query;
N represents a target response count of responses to the query received from the responders; and
L represents F_{N+1}.

15. The method of claim 1:
at least one agent associated with at least one contact item associated with the agent; and
presenting the response to the user comprising: presenting with the response the at least one contact item associated with the agent.

16. The method of claim 1:
the query associated with at least one product;
an agent providing an offer relating to at least one product associated with the query; and
presenting the response to the user comprising: presenting with the response at least one offer associated with at least one product associated with the query.

17. The method of claim 1, the instructions configured to:
detect a transaction completed by the user resulting from a response to the query received from a responder; and
upon detecting the transaction, award a commission to the responder.

18. The method of claim 17:
the query relating to a product offered by a vendor; and
awarding the commission comprising: awarding to the selected response a commission from the vendor of the product.

19. A system configured to elicit at least one response to a query of a user from at least one agent of an agent set, the system comprising:
an agent selecting component configured to:
for respective agents, estimate a response probability of the agent to the query; and
select at least one responder based on, for respective agents who may be capable of providing a response that is relevant to the query, the response probability to the query;
a query offering component configured to, for respective responders, offer the query to the responder for a response fee; and
a response receiving component configured to, upon receiving a response from a responder:
charge the response fee to the responder, and
present the response from the responder to the user.

20. A computer-readable storage medium comprising instructions that, when executed on a processor of a device defining a target response count, elicit from at least one agent of an agent set at least one response to a query of a query type received from a user at a query time, the user having at least one association with at least one associated user within a social network, respective agents associated with at least one contact item and specifying an response cost for the agent in generating a response to a query and submitting a response bid for queries of respective query bid types, by:
training a first learning component to select, for respective training queries of a training query set, at least one selected associated user who may be capable of providing a response that is relevant to the training query;
training a second learning component to estimate, for respective agents and for respective training queries of a training query set, a response probability and a response relevance of the agent to the training query;
invoking the first learning component to select from the associated users at least selected one associated user who may be capable of providing a response that is relevant to the query;
offering the query to the at least selected one associated user;
for respective agents, invoking the second learning component to estimate the response probability of the agent to the query and the response relevance to the query of a response from the agent;
selecting at least one responder based on the target response count and, for respective agents who may be capable of providing a response that is relevant to the query, the response probability to the query, the response cost, the response bid for the query type of the query, and the response relevance;
for respective responders, offering the query to the responder for a response fee;
upon receiving a response from a responder at a response time elapsing after the query time:
charging to the responder a response fee discounted by the response cost and adjusted based on a response time, the response fee comprising an initial response fee and a user interaction response fee calculated according to a mathematical formula comprising:
$$Initial Response {Fee}_{{S}_{i}} = \{ \begin{matrix}if {F}_{i} \geq L \text{:} Max ( L , \frac{{c}_{i}}{{P}_{i}} ) \\ if {F}_{i} \geq L \text{:} {F}_{i}\end{matrix} \\ and \\ User Interaction Response {Fee}_{{S}_{i}} = \{ \begin{matrix}if {F}_{i} \geq L \text{:} 0 \\ if {F}_{i} \geq L \text{:} \frac{( L - {F}_{i} )}{{R}_{i}}\end{matrix}$$
wherein:
S represents the agents of the agent set;
Sᵢ represents an agent i in the agent set;
Cᵢ represents an response cost of agent Sᵢ for generating the response to the query;
Pᵢ represents a response probability estimated for receiving a response from agent Sᵢ to the query;
Rᵢ represents a response relevance to the query of the response received from agent Sᵢ;
Fᵢ represents a base response fee to be charged to agent Sᵢ upon receiving the response to the query, computed according to a mathematical formula:
$${F}_{i} = Max ( {R}_{i} \times {B}_{i} , \frac{{c}_{i}}{{P}_{i}} )$$
wherein:
Bᵢ represents a bid received from the agent to respond to the query;
N represents a target response count of responses to the query received from the responders; and
L represents F_{N+1};
presenting the response from the responder to the user with at least one contact item of the responder;
upon receiving a response from a selected associated user, presenting to the user the response from the selected associated user with a visual presentation similar to the visual presentation of the at least one response from at least one responder;
detecting a transaction completed by the user resulting from a response to the query received from a responder; and
upon detecting the transaction, awarding a commission to the responder.
